(19) United States
(12) Patent Application Publication
(10) Pub. No.: US 2004/0149862 A1
(43) Pub. Date: Aug. 5, 2004

(54) Bus duct support method and bus duct support

(76) Inventors: Yukihiko Yamada, Yamato-shi (JP); Yusuke Tamano, Yokosuka-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/476,186

(22) PCT Filed: May 23, 2002
(86) PCT No.: PCT/JP02/04989

(30) Foreign Application Priority Data
Jun. 6, 2001 (JP) 2001-170557

(51) Int. Cl. F16L 3/00

(52) U.S. Cl. 248/49

(57) ABSTRACT

The invention provides a bus duct supporting structure in which it is possible to minimize the distance between bus ducts next to each other and reduce space for installation of the bus ducts. In the bus duct supporting structure, bus ducts of a plurality of lines installed in parallel almost in the vertical direction of a structure are supported, wherein each bus duct is supported by supporting parts that are fixedly installed on the structure, and supporting parts that support one bus duct and supporting parts that support another bus duct, the bus ducts being next to each other, are disposed at a distance therebetween in the longitudinal direction of a bus duct. For example, with respect to bus ducts that are installed in parallel penetrating through a plurality of floors of a structure, one bus duct is supported by a supporting part while another bus duct is not supported by a supporting part on a first floor, and the other bus duct is supported by a supporting part while the one bus duct is not supported by a supporting part on a second floor which is one floor higher than the first floor.

### BACKGROUND OF THE INVENTION

1. Technical Field

The present invention relates to a bus duct that constructs an electric main line in a structure such as a high building, and particularly relates to a bus duct supporting structure and a bus duct supporting apparatus that support bus ducts of at least two routes installed in the vertical direction.

2. Background Art

To support a bus duct to be installed in the vertical direction in a high building or the like, bus duct supporting apparatuses are used, and for some bus duct supporting apparatuses, the fact that a bus duct is heavier and more rigid compared to a cable and that expansion and shrinkage of the bus duct are caused by a change in temperature due to the change in the state from using with current carrying to non-using is taken into account.

As a related art to bus duct supporting structures using bus duct supporting apparatuses, there is a supporting structure of a vertical bus duct cable path disclosed in JP-A-54-66491. In the supporting structure of a vertical bus duct cable path, with respect to a bus duct cable path penetrating through each floor of a high building almost in the vertical direction, supporting fittings are planted on the floor part at the supporting part on each floor. On the other hand, on the side part of the bus duct, projecting arm parts are provided, then the arm parts are mounted on the fixing fitting through springs so that the bus duct is spring-supported in all the installing division, thereby shrinkage and expansion of the bus duct are absorbed, and also, at proper supporting parts out of the spring supporting parts, second springs are provided to restrict the upward moving of the bus duct.

Further, as a related art other than supporting of ducts, in JP-UM-A-52-115900, a bus duct apparatus in which housings of a contact type insulating bus duct are arranged almost in a box shape without a projecting fringe on the side face thereof, a plurality of lines thereof are disposed in such a manner that the positions of connecting parts alternate with each other, and the distance between the connecting parts and a bus duct next to each other is set to a minimum requirement by the execution task is disclosed.

Also, as another related art other than supporting of ducts, in JP-UM-B-43-11876, an expansion bus duct provided such that the elastic housing body is lifted or pushed down for the height dimension of the body of the duct is disclosed, and also, a construction in which expansion parts of each line are mounted with a shift.

However, in the bus duct supporting structure in JP-A-54-66491, to support a bus duct of a single line to be installed vertically penetrating through each floor, a spring supporting part comprised of a supporting fitting, a spring, and the like is provided on the floor part on every floor, but for bus ducts provided vertically in a high building or the like, a plurality of lines are often installed for the convenience of branching. In the case that bus ducts of more than one line to be installed in the vertical direction are supported by the bus duct supporting structure described above, it is required to secure a distance to install spring supporting parts next to each other and a distance for the installation task of spring supporting parts next to each other, and accordingly, it is required to install bus ducts, securing enough distances between bus ducts next to each other. Therefore, there is a problem that the space for installing the bus ducts includes a wasteful portion. This wasteful installation space increases more significantly as the number of lines increases more and more.

Further, in the above mentioned bus duct supporting structure, to support a bus duct of a single line to be installed in the vertical direction, the installation task of spring supporting parts comprised of supporting fittings, springs, and the like must be carried out on each floor of a building, which requires a lot of labors for the installation task. Particularly, when bus ducts installed in the vertical direction are provided in a plurality of lines, as the number of lines increases, or the building is higher with an increased number of floors, the labor required for the installation task is huge, increasing the disadvantage of lower executability and an increased execution cost such as the labor cost.

Also, in the bus duct supporting structure described above, since spring supporting parts comprised of supporting fittings, springs, and the like are installed on each floor of a building to support a bus duct of a single line, a large number of supporting fittings, springs, and the like are required. Particularly, if bus ducts include a plurality of lines, and further as the number of the lines increases and also the building is higher with an increased number of floors, more supporting fittings, springs, and the like are required, causing a problem of increasing manufacturing cost and procuring cost for the spring supporting parts.

The invention aims at solving the above problems, relates to supporting of bus ducts of a plurality of lines to be installed in the vertical direction in a structure such as a high building, and makes it possible to minimize the distances between bus ducts next to each other and save installation space for bus ducts. In other words, an object of the invention is to provide a bus duct supporting structure and a bus duct supporting apparatus that permit installation of a bus duct system of a plurality of lines and supporting of the bus duct easily even in a small space in which installation of bus ducts of a plurality of lines has been difficult.

Another object of the invention is to provide a bus duct supporting structure and a bus duct supporting apparatus that allow supporting of bus ducts by fixed-installation of supporting parts in a small fixed-installation space of a structure easily, even in the case that, in supporting bus ducts by known bus duct supporting apparatuses, it is difficult to secure a space on a floor face for fixed installation of supporting apparatuses of each line to support each of the bus ducts of a plurality of lines.

Still another object of the invention is to provide a bus duct supporting structure and a bus duct supporting apparatus that can support bus ducts of a plurality of lines to be installed vertically in a structure such as a high building with lower cost and high executability.

### DISCLOSURE OF THE INVENTION

A bus duct supporting structure according to the invention is a structure for supporting bus ducts of a plurality of lines installed on a structure in parallel almost in the vertical direction, and is characterized in that each bus duct is supported by supporting parts that are fixedly installed on the structure, and the supporting parts that support one bus duct and the supporting parts that support another bus duct, the bus ducts being next to each other, are installed at a distance therebetween in the longitudinal direction of the bus ducts. Or, the bus duct supporting structure according to the invention is a structure in which bus ducts of more than one lines are installed on a structure vertically, wherein each installed bus duct is supported by a plurality of supporting parts of bus ducts provided at a proper interval on the structure and supporting parts next to each other are disposed at a distance in the longitudinal direction.

Another bus duct supporting structure according to the invention is characterized in that the bus ducts are installed in parallel penetrating through a plurality of floors of the structure, the one bus duct is supported by the supporting part while the other bus duct is not supported by the supporting part on a first floor, and the other bus duct is supported by the supporting part while the one bus duct is not supported by the supporting part on a second floor which is one floor higher than the first floor. Or, in this bus duct supporting structure, supporting parts of bus ducts next to each other are provided alternately for every two floors.

Still another bus duct supporting structure according to the invention is characterized in that the bus ducts are installed in parallel penetrating through the plurality of floors of the structure, the one bus duct is supported by the supporting part that is fixedly installed on the ceiling on the first floor, and the other bus duct is supported by the supporting part that is fixedly installed on the floor on the second floor which is one floor higher than the first floor. Or, in this bus duct supporting structure, it is also possible that the supporting part on the ceiling and the supporting part on the floor are reversed, then the one bus duct is supported by the supporting part which is fixedly installed on the floor of the first floor, and the other bus duct is supported by the supporting part which is fixedly installed on the ceiling of the second floor. Or, in the bus duct supporting structure, the supporting parts of bus ducts next to each other are provided on the ceiling and the floor alternately on each floor.

Yet another bus duct supporting structure according to the invention is characterized in that vibration insulating parts that insulate vibration of predetermined ducts are provided. For example, almost at the same height or almost on the same floor, the one bus duct or the other bus duct is supported by the supporting part, and the other bus duct or the one bus duct is insulated from vibrating by the vibration insulating part.

Also, another bus duct supporting structure according to the invention is characterized in that the vibration insulating part is provided at the supporting part that supports the one bus duct or the other bus duct, and insulates vibration of the other bus duct or the one bus duct. The vibration insulating part that insulates vibration of the other bus duct or the one bus duct is installed at the supporting part that supports the one bus duct or the other bus duct.

Still another bus duct supporting structure according to the invention is a structure for supporting bus ducts of a plurality of lines that are installed in parallel in a same direction which is almost the vertical direction of a structure, and is characterized in that each bus duct is supported by a first supporting part that is fixedly installed on the structure and supported at an end part in the lateral direction of a bus duct, or by a second supporting part that is fixedly installed on the structure and supported at an end part of the thickness direction of a bus duct, wherein, almost at a same height or almost on a same floor, one bus duct is supported by the first supporting part, and another bus duct, the one bus duct and the other bus duct being next to each other, is supported by the second supporting part. In this bus duct supporting structure, bus ducts of a plurality of lines are installed in parallel in almost the vertical direction of the structure, and each bus duct is supported by a supporting part that is fixedly installed on the structure, wherein as supporting parts, first supporting parts which support ducts at the end part in the lateral direction of the ducts and second supporting parts which support ducts at the end part in the thickness direction of the ducts are provided, and one bus duct is supported by the first supporting part and another bus duct, the ducts being next to each other, is supported by the second supporting part.

Yet another bus duct supporting structure according to the invention is characterized in that the bus ducts are installed penetrating through a plurality of floors of the structure, the one bus duct is supported by the first supporting part and the other bus duct is supported by the second supporting part on a first floor, and the other bus duct is supported by the first supporting part and the one bus duct is supported by the second supporting part on the second floor which is one floor higher than the first floor.

Still another bus duct supporting structure according to the invention is characterized in that there is provided, at least, a place where a first supporting apparatus constructing the first supporting part is installed only at one end in the lateral direction of a duct, thereby supporting the bus duct, or a place where a second supporting apparatus constructing the second supporting part is installed only at one end in thickness direction of a duct, thereby supporting the bus duct.

A bus duct supporting apparatus according to the invention is fixedly installed on a structure, supports a bus duct which is installed almost in the vertical direction of the structure, and is characterized in that, on a body of the supporting apparatus that supports the bus duct, a vibration insulating part that insulates vibration of another bus duct which is installed in parallel to the former bus duct, the bus ducts being next to each other, is provided. An apparatus that supports bus ducts of a plurality of lines installed almost in the vertical direction of a structure is comprised of a body of the apparatus which supports the one duct and, a vibration insulating part which insulates vibration of another bus duct, the bus ducts being next to each other, wherein the vibration insulating part is provided on the body.

A first supporting part and a second supporting part, or a first supporting apparatus constructing the first supporting part and a second supporting apparatus constructing the second supporting part, herein, may be arranged such that the supporting forces thereof for supporting bus ducts are of the same value, however, it may be that, for example, the first supporting part and the second supporting part, or the first supporting apparatus that constructs the first supporting part and the second supporting apparatus that constructs the second supporting part are different in the amount of spring members which support the bus ducts or in the value of supporting forces (spring constant) of the spring members, and thus the first supporting part and the second supporting part, or the first supporting apparatus that constructs the first supporting part and the second supporting apparatus that constructs the second supporting part have different values of forces for supporting the ducts.

Further, it is possible to arrange the first supporting part by providing the first supporting apparatus at each of both ends in the lateral direction of a bus duct, or providing the first supporting apparatus at one end in the lateral direction of the bus duct, or the like, and also, it is possible to arrange the second supporting part by providing the second supporting apparatus at each of both ends in the thickness direction of the bus duct, or providing the second supporting apparatus at one end in the thickness direction of the bus duct. Still further, when providing supporting parts such as the first supporting part or the second supporting part at a proper interval in the longitudinal direction of the bus duct, it is possible to provide, at an end in the lateral direction or the thickness direction of the duct at proper places, supporting apparatuses such as the first supporting apparatus or the second supporting apparatus at both ends or on one end, or make a difference in the values of the supporting forces of a plurality of supporting parts which support the respective bus ducts at proper places. For example, it is possible to install the first supporting apparatuses or the second supporting apparatuses or both of them at one end and at the other end alternately in the longitudinal direction of the bus duct, or install supporting apparatuses in a spiral in the longitudinal direction of the duct, or do the like.

In a bus duct supporting structure according to the invention, bus ducts of more than one line to be installed in parallel in the vertical direction are, for example, supported by supporting parts provided at positions at a distance between ducts next to each other in the longitudinal direction, thus, for example, with respect to the distance between the bus ducts, it is only required to secure an installation space for a single supporting part that supports at least one bus duct, or a single supporting apparatus which constructs the supporting part, or a space that permits installation task, which minimizes the distance between the parallel installation or the distance between installation of bus ducts and eliminates the requirement of securing a wasteful space. Thus, even in a space where it has been impossible to install bus ducts of a plurality of lines previously, the bus ducts of the plurality of lines can easily be installed and supported.

Further, a construction such that one bus duct is supported by a supporting part and another bus duct is not supported by a supporting part on a first floor, and the other bus duct is supported by a supporting part and the one bus duct is not supported on a second floor, or a construction such that supporting parts of bus ducts next to each other are provided alternately on every two floors, makes it possible to eliminate a wasteful space by minimizing the space for parallel installation, and further the space for fixed-installation of the supporting parts, and in addition, does not require providing a supporting part on every floor for a single duct, in other words, it is not required to provide a supporting part on each floor for each bus duct, which enables reducing manufacturing cost and execution task as much as possible.

Still further, although the supporting parts installed on respective floors to support the respective bus ducts may be installed all on the floors or all on the ceilings, one bus duct may be, for example, supported by a supporting part which is fixedly installed on the ceiling of the first floor, and another bus duct may be supported by a supporting part which is fixedly installed on the floor on the second floor, or supporting parts of the bus ducts next to each other are provided on the ceiling and the floor of each floor alternately, and thereby it is possible to minimize the distance between the parallel installation, and further minimize the fixed-installation space of the supporting parts to eliminate wasteful space, which allows reduction in manufacturing cost and execution task as much as possible, and also realizes supporting of various bus ducts to enable supporting of bus ducts fitted for execution sites. For example, if a space to fixedly install a supporting part that supports a bus duct is not available on the floor on an arbitrary floor because, for example, equipment is installed, the bus duct can be supported by a supporting part fixedly installed on the ceiling of the floor which is one floor lower than the arbitrary floor, or in another way, thereby making it possible to act, depending on the condition of the execution site.

Yet further, for example, in such a manner that almost at the same height or almost on the same floor, a vibration insulating part to insulate vibration at least almost in horizontal of one bus duct is provided on another bus duct next to the one duct supported by a supporting part, or in another way, by providing an insulating part for insulating vibration of a predetermined duct, depending on necessity, the distance between the parallel installation and further the space for fixed-installation of a supporting part can be minimized to eliminate wasteful space, or the manufacturing cost and the execution task can be reduced as much as possible, or bus duct supporting adapted to execution sites is made possible by realizing supporting of various bus ducts, and also, it is possible to eliminate or minimize vibration of a bus duct which is not supported by a supporting part on an arbitrary floor, for example. Further, it is preferable that the vibration insulating part is provided on the supporting part or the supporting apparatus that constructs the supporting part, which relieves the necessity of providing another vibration insulating part on the bus duct which is not supported, allowing reduction in cost. Vibration insulating parts may be provided on the same floor at all places where supporting parts are not installed or at partial places in necessity, or on all floors or floors in necessity.

Further, in a structure of supporting bus ducts of more than one line which are installed in parallel and in the vertical direction for example, almost at the same height or almost on the same floor, one bus duct is supported by a first supporting part at an end in the bus duct lateral direction, also, another bus duct next to the one bus duct is supported by a second supporting part at the end in the bus duct thickness direction, and thus spring members, for example, of supporting parts next to each other do not interfere with each other, thereby minimizing the distance between the parallel installation of the bus ducts and also the space for fixed-installation of the supporting parts so that wasteful space can be eliminated. Still further, by providing supporting parts such as the first supporting part and the second supporting part on each floor or at a proper interval in the vertical direction, or on the floor or the ceiling of each floor, the invention is applicable to the case that the ceiling of each or an arbitrary floor is high for example, making it possible to provide supporting parts at a predetermined interval in the vertical direction of a bus duct, and is also easily applicable to supporting of bus ducts with a large volume and a heavy weight or various kinds of bus ducts.

Still further, by a construction such that one bus duct is supported by a first supporting part and another bus duct is supported by a second supporting part on a first floor, and the other bus duct is supported by the first supporting part and the one bus duct is supported by the second supporting part on a second floor, or by a construction such that the first supporting part and the second supporting part of bus ducts next to each other are alternately provided on every two floors, it is possible to minimize the distance between parallel installation the bus ducts and also the space for fixed-installation of the supporting parts to eliminate a wasteful space. Yet further, by providing the supporting part of the first supporting part, the second supporting part, or the like, on each floor or on the floor or the ceiling of each floor, the invention is applicable to the case that the ceiling of each floor or an arbitrary floor is high, for example, which makes it possible to provide supporting parts at a predetermined interval in the vertical direction of the bus duct and easily apply the invention to supporting of bus ducts with a large volume and a heavy weight or various kinds of bus ducts.

Also, for example, it may be that only one end side in a bus duct lateral direction such as a front face supports first supporting parts and only one end side of the bus duct thickness direction such as a side face supports second supporting parts. In such ways or another, the places for supporting the bus duct by installing the first supporting apparatuses constructing the first supporting parts are provided only at one end in the bus duct lateral direction, or the places for supporting the bus duct by installing the second supporting apparatuses constructing the second supporting parts are provided only at one end in the bus duct thickness direction, and thus it is possible to omit installation of supporting apparatuses at places where it is hard to reach hands such as tedious execution task on the rear side, thereby improving the executability and reducing the cost. Almost at the same height or almost on the same floor, execution of supporting apparatuses, at necessary places that are located on the periphery, viewed from top, of bus ducts that are installed in parallel may be omitted.

By the use of a bus duct supporting structure or bus duct supporting apparatuses according to the invention, with regard to supporting of bus ducts of a plurality of lines installed in the vertical direction on a structure such as a high building or the like, the distance between the bus ducts installed next to each other can be minimized, having an effect of allowing reduction in the space required by the installation of the bus ducts. In other words, even at a place in a small space where it was difficult or impossible to install bus ducts of a plurality of lines previously, installation thereof is easily made possible, and the bus ducts can be supported.

Further, even in the case, in supporting bus ducts with known bus duct supporting apparatuses, it is impossible to secure enough space on a floor for fixed-installation of supporting apparatuses of respective lines which support bus ducts of a plurality of lines, a bus duct supporting structure or a bus duct supporting apparatus according to the invention have an effect of allowing easy fixed-installation of supporting parts in a small space of a structure for fixed-installation to support bus ducts.

For example, since it is not necessary to support bus ducts to be installed in the vertical direction in such a manner that supporting parts are supported next to each other and it is possible to install the supporting parts such that the supporting parts do not interfere with each other, it is unnecessary to secure the distance required for installation of the supporting parts next to each other between bus ducts next to each other; the distance required for installation of the supporting parts next to each other in the same direction between the bus ducts next to each other; or the distance required for executing the installation task of the supporting parts next to each other or the supporting parts next to each other in the same direction, which are wasteful distances. Thus, it is possible to secure a minimum required space including a space for installation of necessary supporting parts and a space necessary for reduced labor power of the installation task of the supporting parts, and restrict the distance between the bus ducts next to each other to the minimum, permitting space saving on the installation space of the bus ducts. Particularly, as the number of lines of bus ducts to be installed increases, the advantage of space saving on installation space becomes more significant.

Also, using a bus duct supporting structure or a bus duct supporting apparatus according to the invention has an effect of allowing supporting of bus ducts of a plurality of lines to be installed in the vertical direction on a structure such as a high building at low cost and with high executability.

For example, by use of the bus duct supporting structures in the first to third embodiments, in supporting bus ducts of a plurality of lines to be installed in the vertical direction, with respect to supporting a bus duct of a single line, it is not necessary to install a supporting part or a supporting apparatus on every floor of a high building or the like, also, it is possible to support the bus ducts by installing supporting parts or supporting apparatuses in approximately half a number compared to a known bus duct supporting structure on partial floors of a building, and thus the labor power required by the task for supporting the bus ducts and installation task of the supporting parts or the supporting apparatuses can be reduced, making it possible to implement high executability and reduce the execution cost including labor cost. Particularly, as the number of lines of the bus ducts increases, or the building becomes higher with an increasing number of floors thereof, the advantage of reduction in the labor power on execution and execution cost becomes more significant.

Further, compared to a known bus duct supporting structure, in the bus duct supporting structures in the first to third embodiments, for example, since it is possible to support bus ducts of a plurality of lines by supporting parts or supporting apparatuses in approximately half a number, manufacturing cost and procuring cost of the supporting parts and the supporting apparatuses can be reduced. Particularly, as the number of lines of the bus ducts increases, or the building becomes higher with an increasing number of floors thereof, the advantage of reduction in manufacturing cost and procuring cost of supporting parts becomes more significant.

Still further, by a bus duct supporting structure or a bus duct supporting apparatus according to the invention, various supporting structures are possible including: a construction such that almost at the same height or almost on the same floor, one bus duct is supported by a supporting part, and another bus duct is not supported by a supporting part or a vibration insulating part is not provided; a construction such that almost at the same height or almost on the same floor, one bus duct is supported by a supporting part and another bus duct is not supported by a supporting part but is provided with a vibration insulating part to insulate vibration; a construction such that almost at the same height or almost on the same floor, one and another bus ducts are respectively supported by two different types of supporting parts; combinations of the above constructions; and the like, and accordingly, depending on the state of the execution site, the volume and the type of bus ducts to be installed vertically, and requirements by the user, an optimum supporting structure can be applied, accomplishing space saving on the installation space of the bus ducts.

Yet further, with respect to supporting of bus ducts to be installed vertically in a plurality of lines, a bus duct supporting structure or a bus duct supporting apparatus according to the invention permits eliminating the necessity of supporting each duct by a supporting part fixed on the floor of each floor, and also permits providing supporting parts that support bus ducts which are fixedly installed on the floor or the like, with a shift in the longitudinal direction of bus ducts.

### BRIEF DESCRIPTION OF THE DRAWINGS

FIG. 1 is a front view showing the state that bus ducts of two lines installed in parallel in the vertical direction are supported in a bus duct supporting structure according to the invention in a first embodiment;

FIG. 2 is an enlarged front view of a supporting part in the bus duct supporting structure in FIG. 1;

FIG. 3 is a right side view of the supporting part in FIG. 2;

FIG. 4 is a fragmentary cross-sectional plan view of the supporting part in FIG. 2;

FIG. 5 is a front view showing the state that bus ducts of three lines installed in parallel in the vertical direction are supported in the bus duct supporting structure according to the invention in the first embodiment;

FIG. 6 is a front view showing the state that bus ducts of two lines installed in parallel in the vertical direction are supported in a bus duct supporting structure according to the invention in a second embodiment;

FIG. 7 is an enlarged front view of the supporting part in the bus duct supporting structure in FIG. 6;

FIG. 8 is a left side view of the supporting part in FIG. 7;

FIG. 9 is a fragmentary cross-sectional plan view of the supporting part in FIG. 7;

FIG. 10 is a front view showing the state that bus ducts of three lines installed in parallel in the vertical direction are supported in the bus duct supporting structure according to the invention in the second embodiment;

FIG. 11 is a front view showing the state that bus ducts of three lines installed in parallel in the vertical direction are supported in a first modified example of the bus duct supporting structure in the first embodiment, the bus duct supporting structure using a vibration insulating part of another example;

FIG. 12 is a fragmentary cross-sectional plan view showing the state that bus ducts of two lines installed in parallel in the vertical direction are supported in a second modified example of the bus duct supporting structure in the first embodiment, the bus duct supporting structure using a vibration insulating part of still another example;

FIG. 13 is an enlarged front view of a supporting part in the state that bus ducts of two lines installed in parallel in the vertical direction are supported in a bus duct supporting structure according to the invention in a third embodiment;

FIG. 14 is a front view showing the state that bus ducts of three lines installed in parallel in the vertical direction are supported in a modified example of the bus duct supporting structure in the first embodiment;

FIG. 15 is a front view showing the state that bus ducts of three lines installed in parallel in the vertical direction are supported in a bus duct supporting structure according to the invention in a fourth embodiment;

FIG. 16 is a fragmentary cross-sectional plan view of a supporting part on a lower floor in FIG. 15;

FIG. 17 is a fragmentary cross-sectional plan view showing the state that bus ducts of three lines installed in parallel in the vertical direction are supported in a first modified example of the bus duct supporting structure in the fourth embodiment; and

FIG. 18 is a fragmentary cross-sectional plan view showing the state that bus ducts of three lines installed in parallel in the vertical direction are supported in a second modified example of the bus duct supporting structure in the fourth embodiment.

### BEST MODE FOR CARRYING OUT THE INVENTION

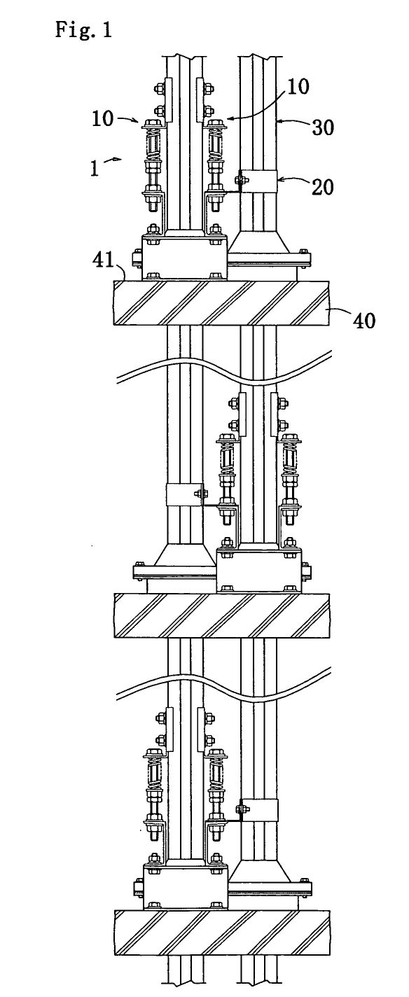

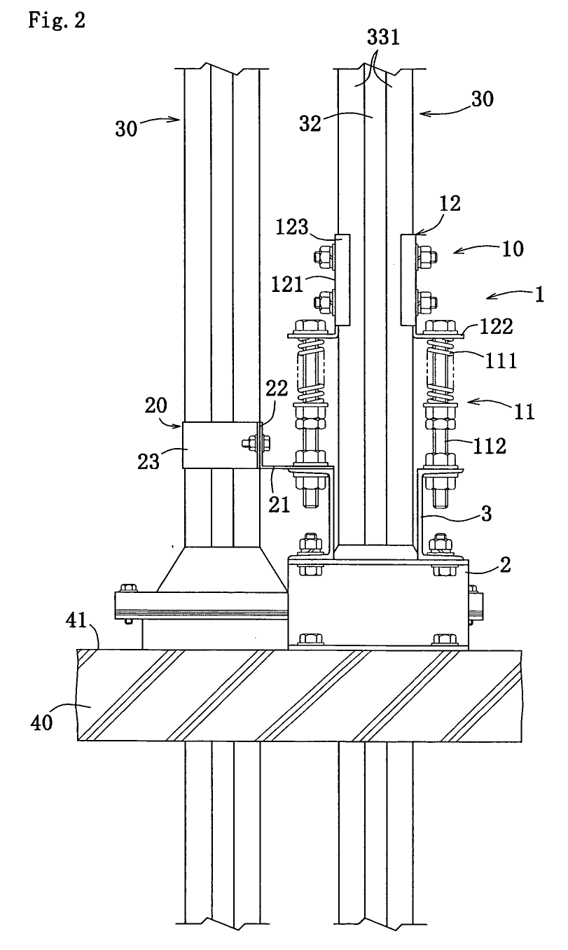

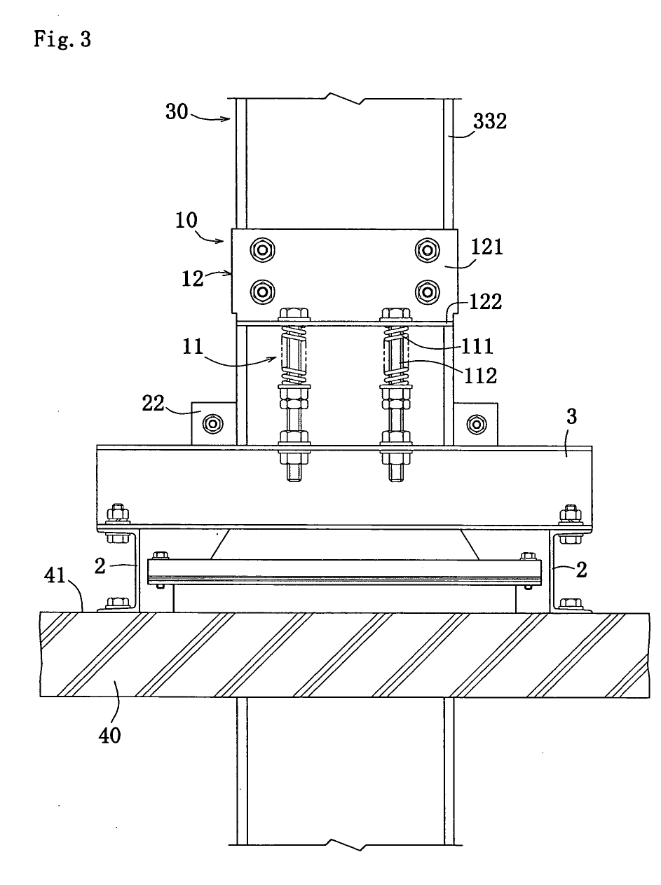

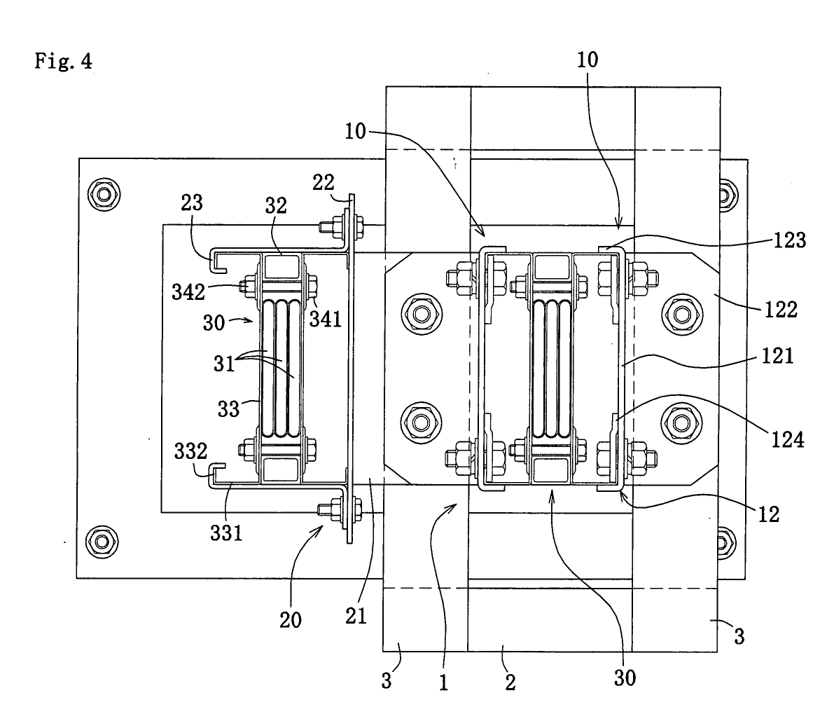

Next, bus duct supporting structures and bus duct supporting apparatuses of the invention will be described with embodiments shown in the drawings, though the invention is not limited to the embodiments. FIGS. 1 to 4 are related to a bus duct supporting structure in a first embodiment, wherein FIG. 1 is a front view showing the state that bus ducts of two lines installed in parallel in the vertical direction are supported in a bus duct supporting structure according to the invention in the first embodiment; FIG. 2 is an enlarged front view of a supporting part therein; FIG. 3 is a right side view of the supporting part in FIG. 2; and FIG. 4 is a fragmentary cross-sectional plan view of the supporting part in FIG. 2.

It is assumed that a bus duct 30 that is supported in the first embodiment and each embodiment described later is a conductor 31 which is insulated with a plurality of phases and covered by a housing, and is constructed such that, as shown in FIGS. 1 to 4, for example, insulated covered conductors 31 of three lines are installed in parallel; spacers 32 whose cross-section is almost in a box shape are intermediately provided in the front and rear in the lateral direction of the insulated covered conductors 31; and the insulated covered conductors 31 and the spacers 32 are sandwiched by side plates 33 from both outsides and fixed by tightening with bolts 341 and nuts 342. The side plates 33 are comprised of a first reinforcing piece 331 that is arranged by bending and extending a flat plate outward from both ends in an angle of approximately 90 degrees, and a second reinforcing pieces 332 that are arranged by bending and extending ends, facing each other outside the first reinforcing piece 331, of the outer edges of the first reinforcing piece 331 in an angle of approximately 90 degrees, and thus the strength of the bus ducts 30 is maintained. The bus ducts 30 are installed, for example, as the two lines in the first embodiment for example, in a plurality of lines in parallel in the vertical direction, penetrating through a floor 40 or a ceiling on each floor of an office building or the like, and thus electric main lines are formed from lower floors to the higher floors of the office building or the like.

In the bus duct supporting structure in the first embodiment, as shown in FIG. 1, bus ducts 30,30 of two lines that are vertically installed in parallel are supported; a supporting part 1 that supports one bus duct 30 is provided on a floor face 41 one very two floors; on floors where a supporting part 1 that supports one bus duct 30 is provided, a supporting part 1 that supports another bus duct 30 is not provided; on each floor, a supporting part 1 that supports only one of the one bus duct 30 or the other bus duct 30 is provided. Further, the supporting part 1 that supports either the one bus duct 30 or the other bus duct 30 is installed one very floor alternately in stagger. Further, on the supporting part 1 that supports either the one bus duct 30 or the other bus duct 30, a vibration insulating part 20 is provided to hold either the other bus duct 30 that is not supported or the one bus duct 30 on each floor, thereby restricting the bus duct 30 that is not supported from moving in the horizontal direction at least.

With the supporting part 1 in the first embodiment, as shown in FIGS. 2 to 4, two first base tables 2,2 made of a channel material with a almost U-shaped cross-section are disposed facing each other on a floor face 41 in the vicinity of penetrating holes of a floor 40 which the bus ducts 30 penetrate through, at the both ends in the lateral direction of the installed bus ducts 30, and fixed on the floor face 41, tightened by bolts. On the facing two first base tables 2,2, two second base tables 3,3 made of a channel material with a U-shaped cross-section are mounted and installed, and each second base table 3 is fixed orthogonal to the first base table 2 by bolts and nuts on the first base table 2. Further, the supporting part 1 is comprised of supporting apparatuses 10, 10 that are disposed facing each other on the both sides in the thickness direction of the bus duct 30, wherein each supporting apparatus 10 is arranged such that a fixing member 12 is disposed above spring members 11 which are on the upper face of the second base table 3 and connect the fixing member 12 and the second base table 3, and further, the supporting apparatus 10, or the spring member 11 and the fixing member 12 are provided on both sides in the thickness direction of the bus duct 30, thereby fixing the fixing member 12 on the bus duct 30 to support the bus duct 30.

Each spring member 11 is comprised of a bolt 112 which penetrates through a spring material 111, wherein the nearly bottom end of the external thread part of the bolt 112 is inserted into an insertion hole, not shown, on the top surface of the second base table 3, and nuts disposed above and below the insertion part are tightened so that the second base table 3 and the spring member 11 are fixed. There is intermediately provided a later described supporting piece 122 of the fixing member 12 between the head part of the bolt 122 and the top end of the spring material 111; a nut is screw engaged below the spring material 111 which is positioned almost at the center of the external thread part, then the bottom end position of the spring material 111 is determined by the nut, and thus the spring material 111 is disposed between the nut at the bottom position and the supporting piece 122. Below the nut at the bottom position of the spring material 111, another nut is further spring engaged to avoid loosening of the nut at the bottom position by the spring member 111. The spring member 11 is provided in a quantity of two on one side of the bus duct 30 and totally in a quantity of four on both sides to absorb and support the weight of the bus duct by the four spring members 11, and deal with the expansion caused by thermal expansion.

Each fixing member 12 is comprised of a base part 121 formed with four bolt insertion holes, not shown, almost in a rectangular shape, a supporting piece 122 arranged by bending the bottom edge of the base part 121 approximately in an angle of 90 degree and extending the edge outward, and a bent part 123 arranged by bending both side edges of the base part 121 approximately in an angle of 90 degree and extending the side edges inward, wherein four fixing fittings 124 are disposed inside the base part 121 corresponding to the bolt insertion holes. The fixing member 12 is provided on both sides in the thickness direction of the bus duct 30 such that the insertion holes the supporting piece 122 is inserted thoroughly with the external thread part of the bolt 112, and the supporting piece 122 disposed between the head part of the bolt 112 and the spring material 111 is supported by the spring material 111, and thus installed almost on the top end of the two spring members 11 for each.

To fix the fixing member 12 to the bus duct 30, bolts are disposed through the fixing fitting 124 inside the second reinforcing piece 332, and the base part 121 is disposed outside the second reinforcing piece 332 so that the inner face of the base part 121 almost at the side end part thereof and the fixing fitting 124 sandwich and support the second reinforcing piece 332; the external thread parts of the bolts are inserted through the bolt insertion holes of the base part 121; the nuts screw engaged with the external thread parts are tightened; and thus the second reinforcing pieces 332 are sandwiched and fixed, thereby insulating the bus duct 30 from vibrating in the thickness direction. In this fixed state, each inner face of the bent part 123 formed on each of both ends of the base part 121 contacts with the outer face of the first reinforcing piece 331 of the bus duct 30, and the outer edge of the fixing fitting 124 and the bent part 123 sandwich the first reinforcing piece 331, thereby insulating the bus duct 30 from vibrating in the lateral direction.

Since movement of the bus duct 30 in the thickness direction is restricted by the base parts 121 of the fixing member 12 and the fixing fittings 124, and movement of the bus duct 30 in the lateral direction is restricted by holding the first reinforcing pieces 331 by the bent part 123, movement of the duct 30 in horizontal directions is restricted entirely. Further, by sandwiching the second reinforcing pieces 332 by the base parts 121 and the fixing fittings 124, the bus duct 30 and the fixing members 12 are maintained to be in the fixing state, thus the weight of the bus duct 30 is absorbingly supported by the spring material 111 that supports the lower edges of the fixing members 12, and also it is possible to deal with expansion of the bus duct 30 caused by thermal expansion. Further, because of the fixing of the fixing members 12 on the duct 30 and the supporting of the bus duct 30 by the supporting part or the supporting apparatus 10, drilling of bolt insertion holes and the like on the housing through the bus duct 30 is unnecessary, which realizes an easy machining task and reduction in cost.

Further, each vibration insulating part 20 that is provided on the supporting part 1 or the supporting apparatus 10 is comprised of a vibration insulating base part 21 in an almost rectangular flat plate shape, a vibration insulating piece 22 which is bent and extended upward from the outer end of the vibration insulating base part 21 almost in an angle of 90 degree, and a pair of vibration insulating fixing fittings 23 with a hook-shaped cross-section which are disposed on almost on both sides of the vibration insulating piece 22, wherein the vibration insulating base part 21 is penetrated by the external thread parts of the bolts 112 of the spring members 11 through insertion holes, not shown, sandwiched and tightened between nuts together with the upper face of the second base table 3 on which the vibration insulating base part 21 is mounted, thus fixed on the upper face of the second base table 3 by the nuts which fix the second base table 3 and the spring members 11 together, while the vibration insulating fixing fittings 23 is, at the base part thereof, fixed to the vibration insulating piece 22 by bolts and nuts which penetrate through the vibration insulating piece 22.

On an arbitrary floor, the vibration insulting part 20 is held by the other bus duct 30 which is not supported by a supporting part 1 next to the bus duct 30 which is supported by the supporting part 1. The vibration insulating part 20 is arranged such that, in the holding state, as shown in FIG. 2, the outer face of the vibration insulating piece 22 and the outer faces of the second reinforcing pieces 332 disposed on the supporting part 1 side of the other bus duct 30 contact each other; the hook parts of the vibration insulating fixing fittings 23 contact the outer faces of the first reinforcing pieces 331 of the other bus duct 30, the outer faces of the spacers 32, and the outer faces of the second reinforcing pieces 332 disposed on the opposite side to the supporting part 10; and the bent parts at the tips of the hook parts of the vibration insulating fixing fittings 23 hold the end fridges of the second reinforcing pieces 332 on the opposite side described above.

The vibration insulating part 20 that holds the bus duct 30 is fixed to the second base table 3 which is fixed to the floor face 41, and thus gets into the fixing state with respect to the floor face 41. Accordingly, by holding the vibration insulating part 20 which is in the fixing state at the other bus duct 30, independently of expansion due to the weight or thermal expansion of the bus duct 30 which is supported by the supporting part 1 or the supporting apparatus 10 which is provided with the vibration insulating part 20, movement of the other bus duct 30 at least in the horizontal direction can be securely restrained.

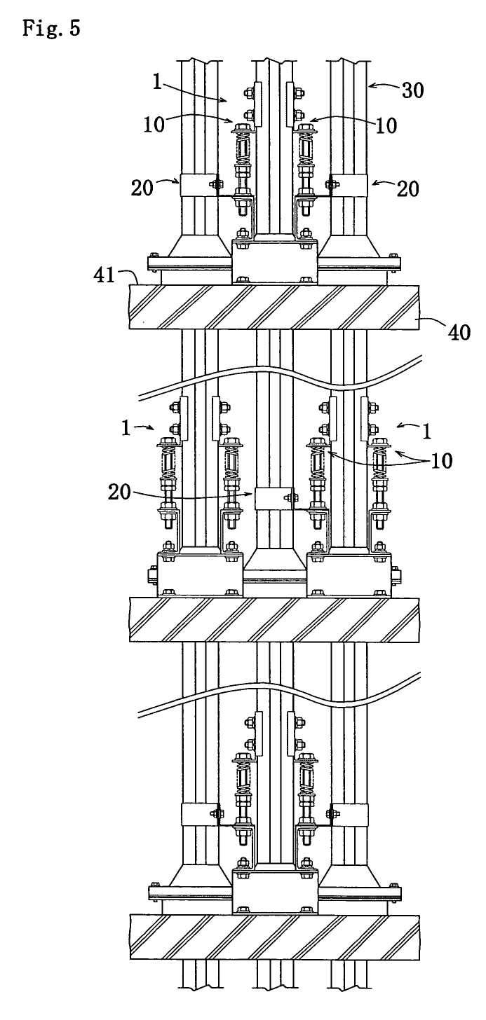

Further, the bus duct supporting structure in the first embodiment also can be applied to the case that bus ducts 30 of more than two lines are installed in the vertical direction in parallel. For example, as shown in FIG. 5, in the case of supporting bus ducts 30 of three lines to be installed in the vertical direction in parallel with use of the supporting part 1 and the supporting apparatus 10 in the first embodiment, the supporting part 1 may be disposed on each floor in stagger in a front view, and on a floor where the central bus duct 30 is supported by the supporting part 1, on the upper faces of the second base tables 3,3 which are disposed on the both sides of the supporting part 1, the vibration insulating parts 20,20 which restrain vibration of the both neighboring bus ducts 30, 30 are respectively provided, and on a floor where the both outer bus ducts 30,30 are respectively supported by the supporting parts 1,1, on the upper face of the second base table 3 of at least one of the supporting parts 1, the vibration insulating part 20 for insulating the central bus duct 30 from vibration is provided, for example.

Herein, the construction may be such that the vibration insulating parts 20,20 are disposed on the upper faces of the second base tables 3,3 of the supporting parts 1, 1 of both the outer bus ducts 30, 30 so that vibration of the central bus duct 30 is restricted. In this case, the vibration insulating piece 22 of the vibration insulating part 20 on either side may be extended for example, and the position of the vibration insulating fixing fitting 23 is preferably arranged by moving it in the longitudinal direction of the bus duct 30, by which the vibration insulating force can be increased. Likewise, also in the case that the bust ducts 30 of more than three lines are installed vertically in parallel, the supporting part 1 may be disposed on each floor in stagger in a front view, and on an arbitrary floor, vibration of the bus duct 30 which is not supported and is next to the bus duct 30 which is supported by the supporting part 1 can be insulated by the vibration insulating part 20. Some of the constructions in each embodiment may be properly adopted in other embodiments.

In the bus duct supporting structure in the first embodiment, even a bus duct 30 that is not supported by a supporting part 1 on each floor can be restrict from moving in the horizontal direction at least, and insulated from vibration, independently of expansion due to the weight and thermal expansion of a bus duct 30 which is supported by the supporting parts 1. Also, although in a structure in which bus ducts 30,30 next to each other are respectively supported by supporting parts 1,1 on a floor face 41, it is impossible to install, for example, second base tables 3, spring members 11, fixing members 12, supporting pieces 122 thereof, and the like, at small distances therebetween, as shown, in the above supporting structure, a bus duct 30 on each floor, next to another bus duct 30 which is supported by a supporting part 1 on the floor face 41, is not supported by a supporting part 1 on the floor face 41, and thus a supporting part 1 or a supporting apparatus 10, which is necessary, can be installed even at small distances therebetween, as shown, eliminating the above problem and making it possible to deal with the case that the distance between bus ducts 30,30 which are next to each other is small with high applicability to execution sites.

Further, compared to a supporting structure in which a supporting part 1 is installed on every bus duct 30 on each floor, by installing a supporting part 1 alternately on each floor, it is possible to narrow a distance between bus ducts 30,30 which are installed next to each other in parallel, and install the bus ducts 30 in parallel in a smaller space, thereby allowing supporting of bus ducts 30 in a smallest possible space with a maximum reduction in a wasteful space for installing the bus ducts 30 in parallel. Still further, since supporting parts 1 in a complicated structure are not next to each other, even in the case that the distance between bus ducts 30, 30 to be installed in parallel is reduced, enough space for performing the task of installing supporting parts 1 of installed bus ducts 30 is secured. By securing an enough space for installation task, necessary labor power for installation can also be reduced.

Still further, compared to the case of providing a supporting part 1 on every bus duct 30 on each floor, the number of supporting parts 1 can be reduced approximately to a half, also, labor power required for the installation task of the supporting parts 1 and the adjustment task of spring members 11 can be reduced approximately to a half at the time of execution, thus reducing the labor power of the installation task and the like, and also reducing the manufacturing cost of the supporting parts 1 and execution cost, etc., which makes it possible to support the bus ducts 30 that are installed in parallel in a lower cost.

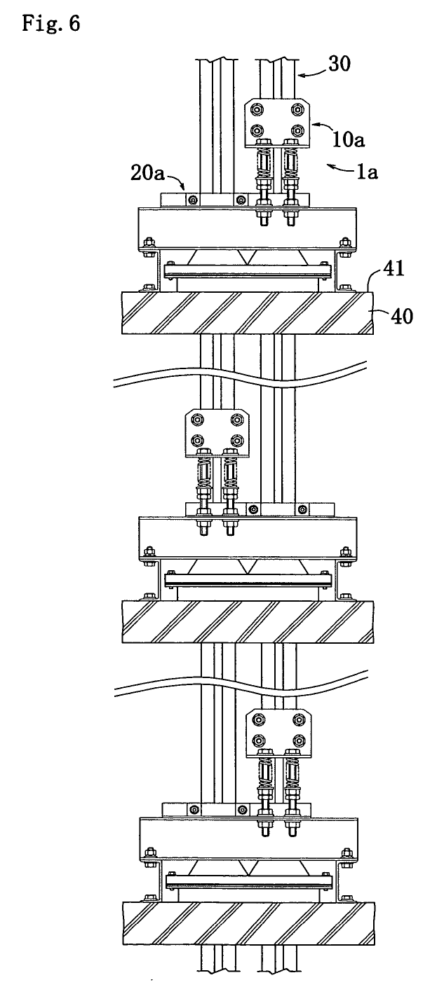

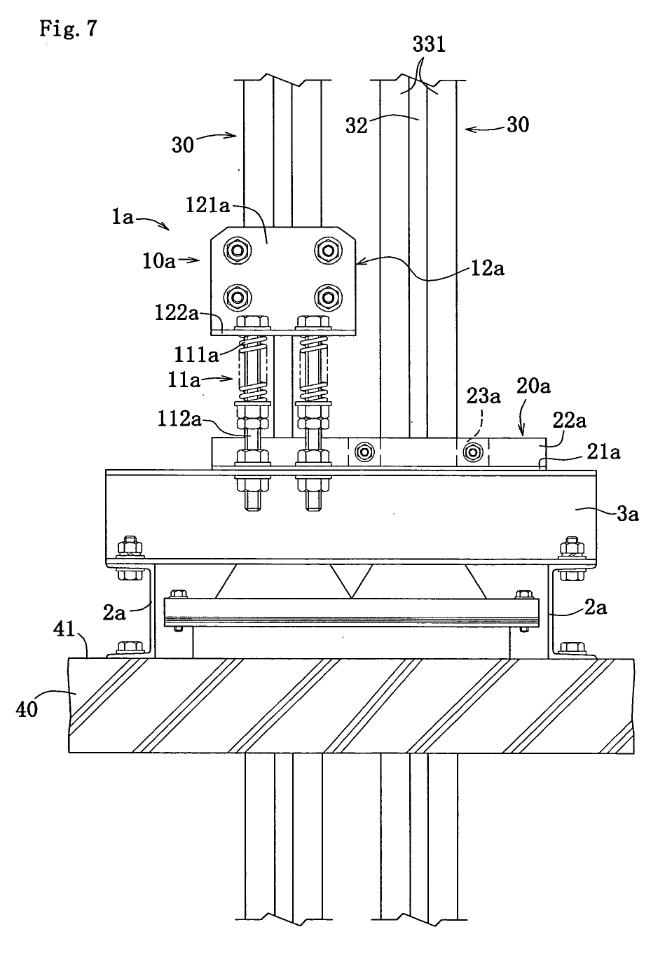

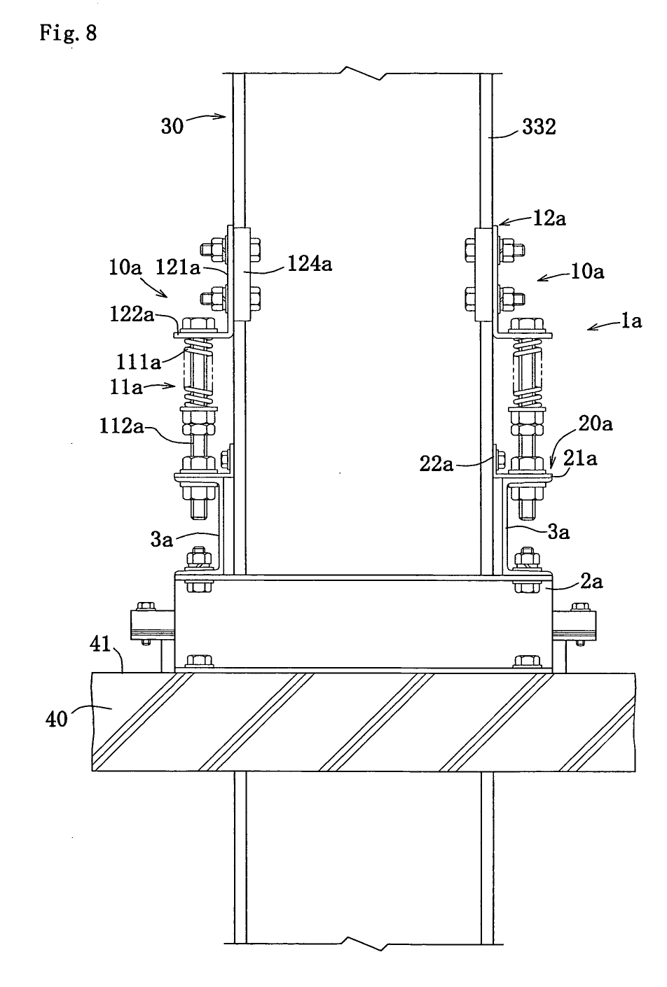

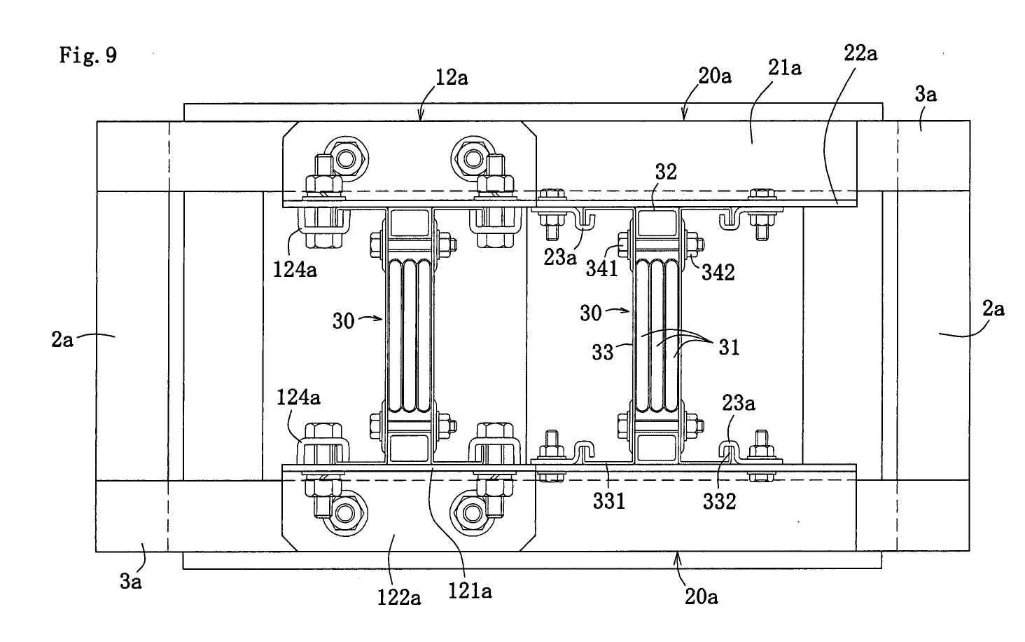

Next, a bus duct supporting structure in a second embodiment will be described, particularly on the points different from the first embodiment. FIGS. 6 to 9 are related to the bus duct supporting structure in the second embodiment, wherein FIG. 6 is a front view showing the state that bus ducts of two lines that are installed in the vertical direction in parallel are supported in the bus duct supporting structure in the second embodiment; FIG. 7 is an enlarged front view of a supporting part thereof; FIG. 8 is a left side view of the supporting part in FIG. 7; and FIG. 9 is a fragmentary cross-sectional plan view of the supporting part in FIG. 7.

Bus ducts 30 that are installed in the vertical direction in parallel in the present embodiment are the same type as the bus ducts 30 in the first embodiment, and as shown in FIG. 6, as same as in the first embodiment, a supporting part 1a that supports only one of one bus duct 30 or another bus duct 30 that are bus ducts of two lines installed in the vertical direction in parallel is provided on each floor, wherein the supporting part 1a on each floor is installed alternately and in stagger in a front view. On each floor, a vibration insulating part 20a is provided on a supporting part 1a to hold either the other bus duct 30 that is not supported by a supporting part 1a or the one bus duct 30, thereby restricting the bus duct 30 from moving in the horizontal direction at least.

With respect to a supporting part 1a, as shown in FIG. 7, two first base tables 2a,2a made of a channel material with an almost U-shaped cross-section are disposed facing each other on a floor face 41 in the vicinity of penetrating holes of a floor 40 which the bus ducts 30 penetrate through, on the both sides in the thickness direction of the installed bus ducts 30, and fixed on the floor face 41, tightened by bolts. On the facing two first base tables 2a, 2a, two second base tables 3a,3a made of a channel material with an almost U-shaped cross-section are mounted and installed, and the second base tables 3a are fixed orthogonal to the first base tables 2a by bolts and nuts on the first base tables 2. Further, the supporting part 1a is comprised of supporting apparatuses 10a, 10a that are disposed facing each other on the both sides in the lateral direction of the bus duct 30, wherein each supporting apparatus 10a is arranged such that a fixing member 12a is disposed above spring members 11a which are on the upper face of the second base table 3a and connect the fixing member 12a and the second base table 3a, and further, the supporting apparatuses 10a, and the spring members 11a and the fixing members 12a are provided on both sides in the lateral direction of the bus duct 30, thereby fixing the fixing members 12a on the bus duct 30 to support the bus duct 30.

The spring member 11a is constructed as the same as the spring member 11 in the first embodiment, comprised of a bolt 112a which penetrates through a spring material 111a, provided on each side in the lateral direction of the bus duct 30 in a quantity of two and totally four on both sides, and mounted and fixed on the second base table 3a in the same manner as that in the first embodiment. On the top of the fixed spring members 11a, fixing members 12a are disposed. Each fixing member 12a is comprised of a base part 121a which is arranged by chamfering an almost rectangular plate at both the upper corners and providing four bolt penetration holes through the plate; and a supporting piece 122a which is arranged by bending and extending the base part 121a at the bottom edge thereof outward in an angle of approximately 90 degrees. The fixing members 12a are disposed such that the base parts 121a contact with both end surfaces in the lateral direction of the bus duct 30 respectively, and fixed to the spring members 11a through the supporting pieces 122a and thereby supported.

Further, on the left and right almost side parts of each base part 121a on the inner side thereof, fixing fittings 124a with an almost U-shaped cross-section are disposed convexly toward inside and fixed by tightening with bolts and nuts penetrated through two bolt penetration holes disposed at upper and lower positions of the almost side part of the base part 121a. Each fixing fitting 124a is disposed on the bus duct 30 such that: the inner side face of the fixing fitting 124a straddles a second reinforcing piece 332 of the bus duct 30; the edge of the inner side face thereof contacts with a first reinforcing piece 331; and the first reinforcing piece 331 is fixed sandwiched by the fixing fittings 124a and the base part 121a and tightened by the bolt and the nut.

Movement of the bus duct 30 in the horizontal direction can be entirely restricted by the base parts 121a and the fixing fittings 124a of the fixing members 12a. Further, as mentioned above, the weight of the bus duct 30 can be absorbingly supported by the spring materials 111a, and also it is possible to deal with expansion of the bus duct 30 caused by thermal expansion. Still further, because of the fixing of the fixing members 12a on the duct 30 and the supporting of the bus duct 30 by the supporting part 1a, as same as in the first embodiment, drilling of bolt insertion holes and the like through the housing of the bus duct 30 is unnecessary, which realizes an easy machining task and reduction in cost.

Further, each vibration insulating part 20a that is provided on the supporting part 1a is comprised of a vibration insulating base part 21a in an almost rectangular flat plate shape, the vibration insulating base part 21a being fixed on the top face of the second base table 3a by penetrating bolts 112a, a vibration insulating piece 22a which is bent and extended upward from the inner end of the vibration insulating base part 21a almost in an angle of 90 degrees, and vibration insulating fixing fittings 23a with a hook-shaped cross-section, vibration insulating fixing fittings 23a being fixed on the inner face of the vibration insulating piece 22a, wherein the vibration insulating base part 21a is fixed together by the nuts which fix the second base table 3a and the spring members 11a, while the vibration insulating fixing fittings 23a are, at the base part thereof, fixed to the vibration insulating piece 22a by bolts and nuts. In the state that the vibration insulating part 20a is mounted on the bus duct 30 which is the object of insulating from vibration, the hook part of each vibration insulating fixing fitting 23a straddles the second reinforcing piece 332 of the bus duct 30; the edge of the second reinforcing piece 332 contacts the inner face of the hook part; the hook part and the vibration insulating piece 22a sandwich and fix the second reinforcing piece 332; and the inner face of the vibration insulating 22a contacts the outer face of the first reinforcing piece 331 of the bus duct 30 and the outer face of the spacer 32.

On an arbitrary floor, the vibration insulting part 20a is held by the other bus duct 30 which is not supported by a supporting part 1a or a supporting apparatus 10a and is next to the bus duct 30 which is supported by a supporting part 1a and a supporting apparatus 10a, and fixed to the second base table 3a which is fixed with respect to the floor face 41 and thus held in the fixing state with respect to the floor face 41. Therefore, independently of expansion due to the weight or thermal expansion of the bus duct 30 which is supported by the supporting part 1a which is provided with the vibration insulating part 20a, movement of the other bus duct 30 at least in the horizontal direction can be securely restricted.

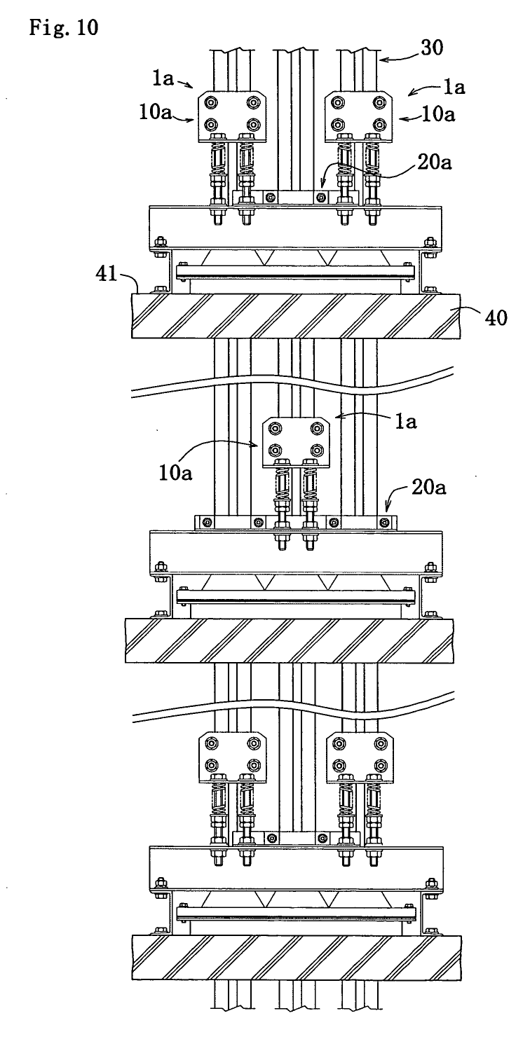

Further, for example, as shown in FIG. 10, in the case of supporting bus ducts 30 of three lines which are installed in the vertical direction in parallel with use of the supporting parts 1a and the supporting apparatuses 10a in the second embodiment, the supporting parts 1a and the supporting apparatuses 10a are disposed on each floor in stagger in a front view; and on a floor where the central bus duct 30 is supported by the supporting part 1a or the supporting apparatus 10a, a vibration insulating part 20a having a vibration insulating base part 21a and a vibration insulating piece 22a which are a little longer than the distance between both the bus ducts 30,30 next to the central bus duct 30 is provided on the upper face of the second base table 3a; the vibration insulating base part 21a is fixed to the fixing part between the spring member 11a of the supporting part 1a or the supporting apparatus 10a and the second base table 3a; and thus both the neighboring bus ducts 30 are insulated from vibration by the vibration insulating fixing fittings 23a which are disposed on both sides of the vibration insulating piece 22a. On a floor where both the outer bus ducts 30,30 are respectively supported by the supporting parts 1a, 1a, a vibration insulating base part 21a that is shorter than the above vibration insulating base part 21a is fixed to the fixing part of the spring members 11a, 11a of both the supporting parts 1a, 1a and the second base table 3a, and the central bus duct 30 is insulated from vibration by the vibration insulating fixing fittings 23a provided almost in the center of the vibration insulating piece 22a.

In this case, two fixing places of the vibration insulating base part 21a and the second base table 3a through the spring members 11a are enough, and for example, the fixing places to fix two spring members 11a for a single bus duct 30 to the second base table 3a may be used; or respective ones out of the fixing places to fix two spring members 11a for the respective bus ducts 30, which are either on both the outer sides or next to each other, to the second base table 3a may be used; or all of the fixing places may be used. Further, likewise, even in the case that more than three bus ducts 30 are installed vertically in parallel, the supporting part 1a is provided on each floor in stagger in a front view, and on an arbitrary floor, a bus duct 30 that is not supported and next to a bus duct that is supported by a supporting parts 1a is insulated from vibration by the vibration insulating part 20a.

In the bus duct supporting structure in the second embodiment, even the bus duct 30 that is not supported by a supporting part 1a or a supporting part 10a on each floor can be restricted from moving in the horizontal direction at least, and insulated from vibration, independently of expansion due to the weight and thermal expansion of the bus duct 30 which is supported by the supporting parts 1a or the supporting apparatuses 10a. Also, although in a structure in which bus ducts 30, 30 next to each other are respectively supported by supporting parts 1a,1a on a floor face 41, it is impossible to install second base tables 3a, spring members 11a, fixing members 12a, base parts 121a thereof, and the like, at small distances therebetween, as shown, for example, but in the above described supporting structure, a bus duct 30 on each floor, next to another bus duct 30 which is supported by a supporting part 1a or a supporting apparatus 10a on the floor face 41, is not supported by a supporting part 1a or a supporting apparatus 10a on the floor face 41, and thus a supporting part 1a or a supporting apparatus 10a, which is necessary, can be installed even at small distances therebetween, as shown, eliminating the above problem and making it possible to deal with the case that the distance between bus ducts 30,30 which are next to each other is short with high applicability to execution sites.

Further, compared to a supporting structure in which a supporting part 1a is installed on every bus duct 30 on each floor, by installing a supporting part 1a alternately on each floor, it is possible to use a small distance between bus ducts 30,30 which are installed next to each other in parallel, and install the bus ducts 30 in parallel in a smaller space, thereby allowing supporting of bus ducts 30 in a smallest possible space with a maximum reduction in a wasteful space for installing the bus ducts 30 in parallel. Still further, since supporting parts 1a in a complicated structure are not next to each other, even in the case that the distance between bus ducts 30,30 installed in parallel is reduced, enough space for performing the task of installing supporting parts 1a or supporting apparatuses 10a of installed bus ducts 30 is secured. By securing an enough space for installation task, necessary labor power for installation can also be reduced. For example, even in the case that a fixing member 12a becomes larger in the thickness direction of a bus duct 30 due to a large number of spring members 11a, since a bus duct 30 that is supported by a supporting part 1 is only one of the bus ducts 30,30, the bus ducts 30, 30 being next to each other, the distance between the bus ducts 30,30 to be installed can be reduced, thus accomplishing saving space.

Still further, as same as in the first embodiment, compared to the case of providing a supporting part 1a or a supporting apparatus 10 for every bus duct 30 on each floor, the number of supporting parts 1a or supporting apparatuses 10a can be reduced approximately to a half, also, labor power required for installation task of the supporting parts 1a or the supporting apparatuses 10a at the time of execution and adjustment task of spring members 11a can be reduced approximately to a half, thus reducing labor power of the installation task and the like, and also reducing the manufacturing cost and execution cost of the supporting parts 1a or the supporting apparatuses 10a, etc., which makes it possible to support the bus ducts 30 installed in parallel in a lower cost.

Although the first embodiment and the second embodiment of the bus duct supporting structures according to the invention have been described above, the invention is not limited to these embodiments, permitting various enhancements and modifications. For example, bus ducts to be supported are not limited to those in the above described embodiments, but may be air insulating bus ducts having out-of-phase conductors at a certain distance therebetween; the construction of the housing thereof is not limited to the above embodiments; and also, the supported bus ducts are not limited to the three line systems in the above embodiments, but may be bus ducts of less than three lines or more than three lines.

The supporting part, also, is not limited to that described in the above embodiments, but may be provided with a bumper material instead of a spring material, or the fixing member may be directly fixed to the housing of the bus duct with a tightening fixing tool such as bolts and nuts, and further, the quantity, the shape, or the like of the construction members are not limited to those in the above embodiments. Further, although the place for fixing a supporting part or a supporting apparatus and a vibration insulating part is not limited to the above embodiment, a place which is in a state being fixed to the floor face is preferable, further, since each line of bust ducts has a different expansion or shrinkage rate, a place where there in no effect by expansion or shrinkage due to the weight or thermal expansion of the bust duct supported by the supporting part is proper. For example, a place below the spring material such as a place on the first base table, on the second base table, or on the floor, is preferable.

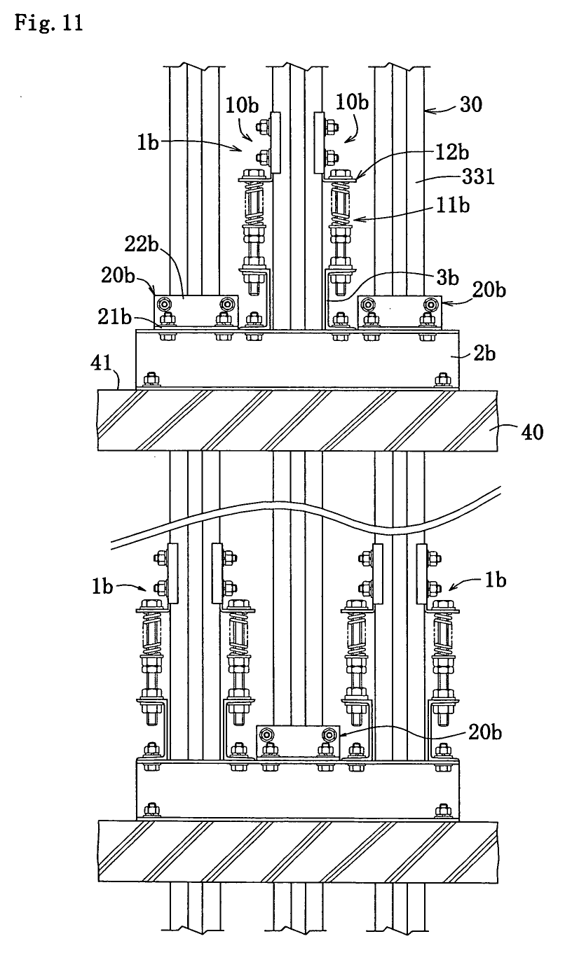

For example, FIG. 11 shows an example of the case of providing the supporting part or the supporting apparatus, and the vibration insulating part on the first base table. In this example, a supporting part 1b or a supporting apparatus 10b same as the supporting part 1 or the supporting apparatus 10 in the first embodiment are used, wherein, regarding the supporting part 1b or the supporting apparatus 10b, a second base table 3b is fixedly mounted on a first base table 2b installed on a floor face 41; on the second base table 3b, a spring member 11b and a fixing member 12b are provided; and as each supporting part 1b, the supporting apparatuses 10b, 10b are disposed facing each other on both sides in the thickness direction of the bus duct 30. The vibration insulating part 20b is a fitting with a cross-section almost in L-shape, and includes a vibration insulating base part 21b almost in a rectangular plate and a vibration insulating piece 22b arranged such that the side edge of the vibration insulating base part 21b is bent upward almost in an angle of 90 degrees and extended upward, wherein the vibration insulating base part 21b is tightened on the first base table 2b with bolts and nuts and fixed; the vibration insulating piece 22b is contacted with the first reinforcing piece 331 of the bus duct 30; and a vibration insulating fixing fitting (not shown) same as the vibration insulating fixing fitting 23a in the second embodiment is used in the state that the hook part of the vibration insulating fixing fitting straddles the second reinforcing piece 332 of the bus duct 30, thereby the second reinforcing piece 332 being sandwiched by the hook part and the vibration insulating piece 22b to be fixed. The vibration insulating parts 20b is provided on each of the both sides in the lateral direction of the bus duct 30 so that the bus duct 30 is insulated from vibration from both ends in the lateral direction of the bus duct 30 by the vibration insulating parts 20b, 20b. The vibration insulating parts have an effect of allowing insulation of vibration and improving executability, independently of the structure of the supporting part.

Although, regarding the vibration insulating part 20b in the above example, a construction in which the vibration insulating part 20b is provided on each of both sides in the lateral direction of the bus duct 30 to insulate vibration has been described, the vibration insulating part 20b may be provided only on side in the lateral direction of the bus duct 30 and vibration is insulated by the vibration insulating part 20b at only one edge portion in the lateral direction of the bus duct 30. In the case of providing the vibration insulating part 20b only on one side in the lateral direction of the bus duct 30, if the vibration insulating part 20b is provided on one side in the lateral direction of the bus duct 30 positioned at the front in front view, installation of the vibration insulating part 20b is needed only at the front, and thus the necessity of installing a vibration insulating part 20b at the rear, where it is difficult to reach hands, is eliminated, thereby favorably improving executability and reducing the quantity of parts. Further, also in the case of providing a vibration insulating part 20b on the second base table 3a in the second embodiment, in the same construction, the same advantage can be obtained.

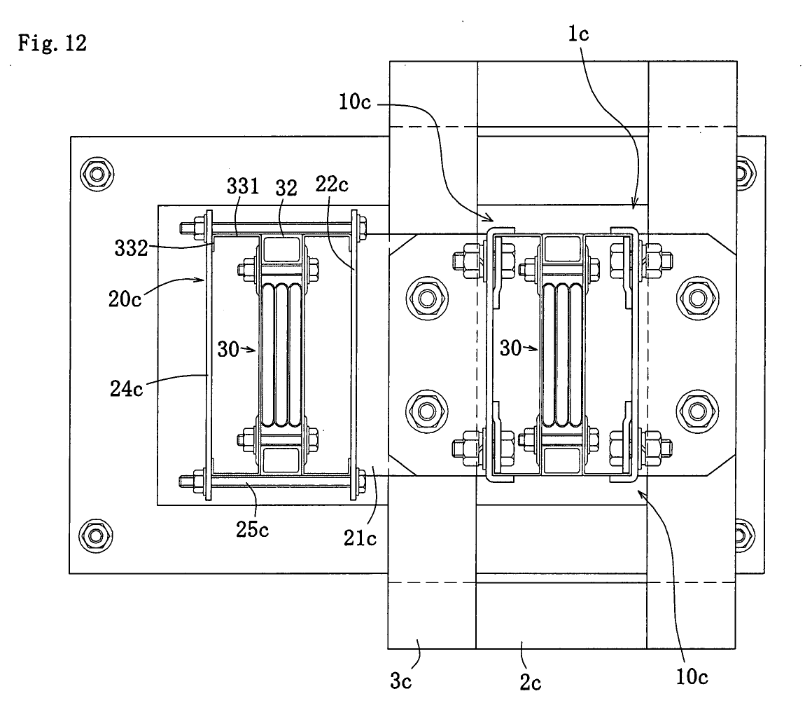

Further, the vibration insulating part is not limited to the above embodiment, and any vibration insulating part that allows at least restriction of movement of a bus duct in the horizontal direction is included in the invention. For example, a vibration insulating part 20c, as shown in FIG. 12, may be employed. The vibration insulating part 20c is used in a modified example of the bus duct supporting structure in the first embodiment, wherein although the vibration insulating part 21c and the vibration insulating piece 22c are constructed as same as the vibration insulating base part 21 and the vibration insulating piece 22 in the first embodiment, there is not a vibration insulating fixing fitting. At the vibration insulating part 20c, a flat pressing plate 24c is provided on the outer face of the second reinforcing piece 332, the outer face being the end face of the bus duct 30 in the thickness direction on the face side which does not contact the vibration insulating piece 22c, long bolts 25c penetrated through the pressing plate 24c and the vibration insulating piece 22c, and nuts are tightened, and the second reinforcing piece 332 is sandwiched by the vibration insulating piece 22c and the pressing plate 24c and thus fixed, restricting movement of the bus duct 30 in the thickness direction. In this case, each long bolt 25c is disposed such that the long bolt 25c contacts with the outer face of the first reinforcing piece 331 of the bus duct 30 and the outer face of the spacer 32 so that movement of the bus duct 30 in the lateral direction is also restricted, and accordingly, the bus duct 30 is restricted from moving in any horizontal direction. With the vibration insulating part 20c in this example, insulation of vibration is more firmly and securely carried out, compared to the vibration insulating parts 20, 20a, or 20b in the above embodiment. The other constructions in the above modified example are the same as those in the first embodiment, wherein reference numerals 1c, 10c 2c, and 3c respectively denote a supporting part, a supporting apparatus, a first base table, and a second base table.

Although in the above embodiments, the construction in which the spring member of the supporting part is provided for each bus duct in a quantity of four, the quantity may be two or more than 5, depending on the capacity or the type of the bus duct. In the case that two spring members are used and the vibration insulating base part of the vibration insulating part and the second base table are fixed at a single place, a bolt other than the bolt of the spring member and a nut are used to directly fix the second base table and the vibration insulating base part, or other arrangements are properly possible.

Further, although in the second embodiment, as shown in FIG. 9, an example in which the vibration insulating fixing fitting 23a and the vibration insulating part 20a are respectively disposed on both the sides in the lateral direction of the bus duct 30 to insulate the bus duct 30 from vibration has been described, it is also possible to dispose the vibration insulating fixing fitting 23a and the vibration insulating part 20a only one side in the lateral direction of the bus duct 30 to insulate vibration by only one vibration insulating part at least. Such a construction makes it possible to reduce the quantity of parts and the cost, and further, when installing the supporting part and the vibration insulating part, for example, the installation task is required only at the front of the bust duct for insulation of vibration, thus eliminating the necessity of installation on the rear face where it is hard to reach hands, thus improving the workability. Likewise in the first embodiment, the same advantage can be obtained by providing the vibration insulating fixing fitting 23 and the vibration insulating part 20 only on one side.

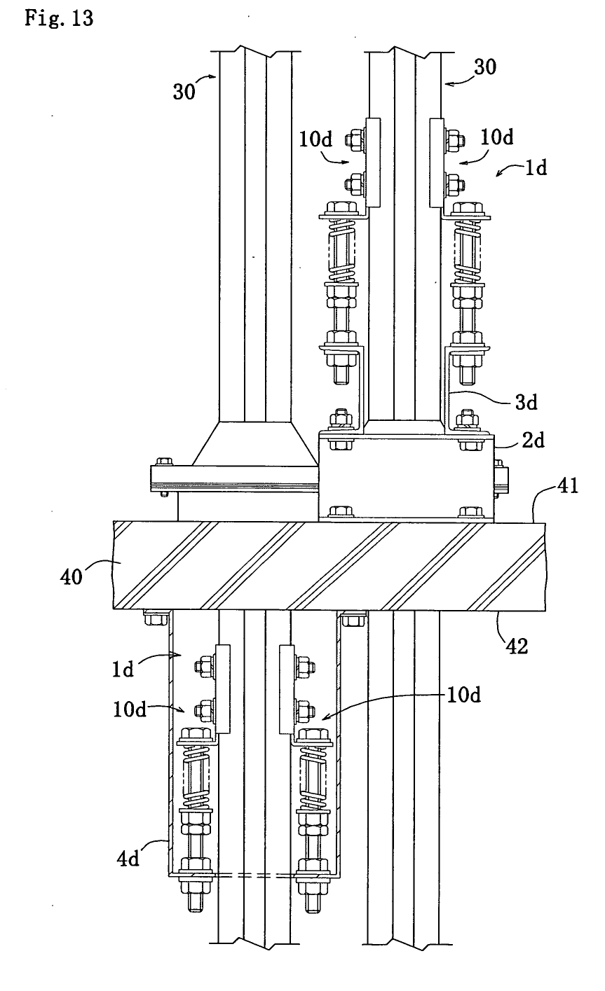

Still further, since a bus duct supporting structure according to the invention includes all the constructions in which supporting parts are disposed with a shift in the longitudinal direction of the bus duct, constructions in which the vibration insulating part in the first and second embodiments is not provided are included, and a construction in which a vibration insulating part is not provided reduces manufacturing cost and execution cost more. Yet further, as the bus duct supporting structure in the third embodiment shown in FIG. 13, for example, a supporting part 1d and a supporting apparatus 10d are installed on a floor face 41 and a ceiling face 42 on each floor, and the supporting part 1d and the supporting apparatus 10d may be shifted in the longitudinal direction of the bus duct 30. Although the supporting part 1d and the supporting apparatus 10d are constructed fundamentally the same as the supporting part 1 and the supporting apparatus 10 in the first embodiment, the supporting part 1d installed on the floor face 41 is not provided with a vibration insulating part, supporting part 10d installed on the ceiling face 42 is not provided with the first table 2d or the second base table 3d, and instead, the supporting part 1d and the supporting apparatus 10d are fixed to the bottom of a box body 4d or a supporting body that is fixedly disposed on the ceiling face 42. The supporting part 1d and the supporting apparatus 10d on the ceiling face 42 are fixed by the box body 4d or the supporting body to be installed easily.

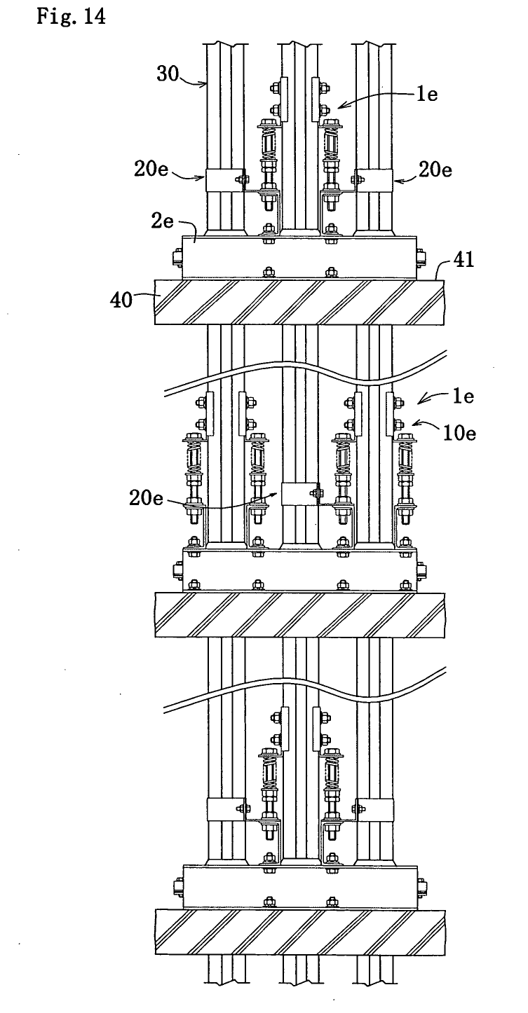

Yet further, although in the above described embodiments, a construction such that the first and second base tables are provided because of fire prevention of floor-penetrating holes, or the like, has been described depending on the fire prevention method, a construction without using base tables is possible. For example, spring members may be directly fixed to the floor face, and in a construction using vibration insulating parts, each vibration insulating part may be directly or indirectly fixed to the floor face, integrally with the spring members or separately, or in contrast, base tables higher than the second base table can be provided, thus allowing installation construction of the supporting part properly. Further, in the case of supporting bus ducts of a plurality of lines, more than two lines specifically, that are installed vertically in parallel in the bus duct supporting structure in the first embodiment, for example, as shown in FIG. 14, a first base table 2e which is long may be used on each floor, or in other ways, thus proper installation constructions being allowed to be employed. Reference numeral 1e denotes a supporting part, reference numeral 10e denotes a supporting apparatus, and reference numeral 20e denotes a vibration insulating part.

Further, although in the above embodiments, a construction in which a supporting part is installed on each floor has been described, the invention is not limited to the above embodiments. For example, a construction such that a supporting part is provided on every two or more floors, a construction such that a supporting part is provided at random, or a construction such that if the capacities or weights of bus ducts in two lines are different, one bus duct with a smaller capacity or weight is supported by a supporting part on every two floors, and the other bus duct with a larger capacity or weight is supported by a supporting part on the floors where the above described one bus duct is not supported by the supporting part, may be employed, and any construction is included in the invention as long as mutual supporting parts of bus ducts next to each other are shifted in the longitudinal direction. In such a manner, compared to known bus duct supporting structures, the quantity of supporting parts can be reduced to a half or less than a half, allowing reduction in manufacturing cost, procuring cost, or execution cost.

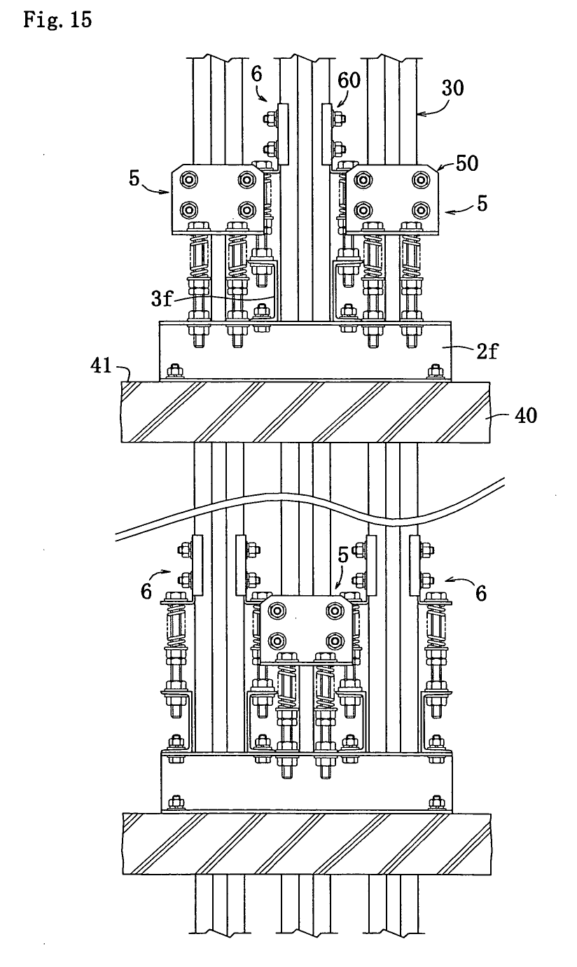

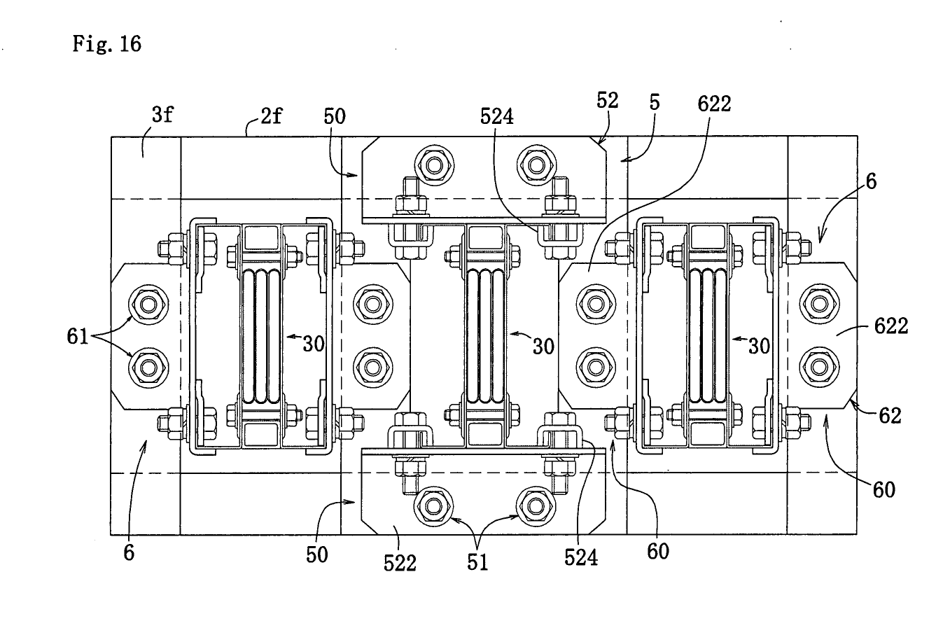

Next, a fourth embodiment according to the invention will be described, mainly focusing on points which are different from the first and second embodiments. FIGS. 15 and 16 relate to a bus dust supporting structure in the fourth embodiment. FIG. 15 is a front view showing the state that bus ducts of three lines installed in parallel in the vertical direction are supported in the bus duct supporting structure in the fourth embodiment, and FIG. 16 is a fragmentary cross-sectional plan view of a supporting part on the lower floor in FIG. 15. Although in the embodiment, fire prevention is not shown and the case of supporting bus ducts installed in three lines is described, the invention includes the case of supporting bus ducts installed in two lines or more than three lines.

In the bus duct supporting structure in the present embodiment, a first base table 2f and a second base table 3f which are longer than the outer distance between bus ducts 30,30 on the right and left sides are disposed in the same state as the state that the first base table 2 and the second base table 3 are disposed in the first embodiment. A first supporting part 5 constructed the same as the supporting part 1a in the second embodiment is fixed on the first base table 2f by tightening bolts and nuts, or the like; a second supporting part 6 constructed similarly to the supporting part 1 in the first embodiment is fixed on the second base table 3f by tightening bolts and nuts, or the like; the first supporting parts 5 are respectively provided on both sides in the lateral direction of the bus ducts 30 to support the central bus duct 30 or both the bus ducts 30 on the right and left sides; and the second supporting parts 6 are respectively provided on both sides in the thickness direction of the bus duct 30 to support the bus ducts 30 that is not supported by the first supporting part 5, that are both the bus ducts 30 on the right and left sides or the central bus duct 30. In other words, almost on the same floor or almost at the same height, mutual bus ducts 30, 30 next to each other are supported by respective different supporting parts, wherein two different types of supporting parts, that are the first supporting part 5 and the second supporting part 6, are alternately provided. Reference numeral 50 denotes a first supporting apparatus, and reference numeral 60 denotes a second supporting apparatus. First supporting apparatuses 50 are provided facing each other, and second supporting apparatuses 60 are provided facing each other, constructing the first supporting part 5 and the second supporting part 6, respectively.

The difference between the second supporting part 6 and the supporting part 1 in the first embodiment is that the second supporting part 6 is formed such that the width of a supporting piece 622 is set to a value that allows disposing the supporting piece 622 between fixing fittings 524, 524 of the first supporting parts 5 that support bus ducts 30 next to each other, and accordingly the disposition distance between spring members 61,61 is narrowed. In such a construction, it is possible to narrow the installation distance between bus ducts 30, 30 more, while other constructions are the same as that of the supporting part 1. Further, the present embodiment also allows, as well as the first to third embodiments, proper modifications including a construction in which supporting parts are directly fixed to the floor or the like, a construction in which only the first base table is provided, a construction in which base tables higher than the second base table are provided, and other constructions are possible.

Still further, in the present embodiment, on the lower floor in FIG. 15, the central bus duct 30 is supported by the first supporting part 5, and the bus ducts 30 on both sides are respectively supported by the second supporting parts 6; on the floor one floor higher than the lower floor, the central bus duct 30 is supported by the second supporting part 6, and the bus ducts 30 on both sides are respectively supported by the first supporting parts 5; thus, the same bus duct 30 is supported by the first supporting part 5 and the second supporting part 6 alternately on each floor; in other words, the bus ducts 30 are supported by the staggered arrangement of the first supporting part 5 or the second supporting parts 6, or the first supporting parts 5 and the second supporting part 6 on the lower floor, the staggered arrangement on the lower floor being different form the staggered arrangement on the floor which is one floor higher; thereby balancing the supporting force and the holding force of the ducts 30 at the front and rear and at the right and left to allows table supporting of the bus ducts 30. Further, it is possible to make the staggered arrangement of the first supporting part 5 and the second supporting parts 6 on the lower floor the same as the staggered arrangement on the floor which is one floor higher, and also possible to modify the arrangement of the first supporting part 5 and the second supporting part 6 for every two floors, or the like, thus allowing proper constructions. It is also possible to make stagger arrangements, the same as described above, of the supporting parts or the vibration insulating parts, or the supporting parts and the vibration insulating parts in the above embodiment.

In the above described construction, between the mutual bus ducts 30,30 next to each other, there is no interference between spring members 51 and 61, between fixing members 52 and 62, and between supporting pieces 522 and 622, which allows, as same as the first and second embodiments, reducing the space between the parallel installation of the mutual bus ducts 30,30, and securing a space enough to execute the installation task of the supporting parts of the installed bus ducts 30, or the first supporting parts 5 and the second supporting parts 6. Since enough space for the installation task is secured, labor power required for the installation can also be reduced.

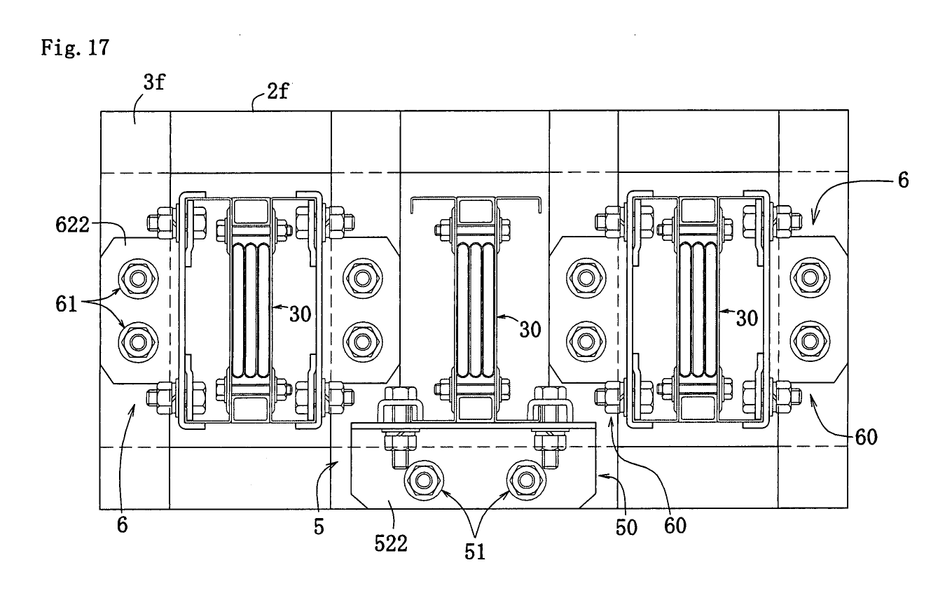

With regard to the supporting parts in the fourth embodiment, the first supporting part 5 and the second supporting part 6 may have different values of supporting forces, or the like, in a proper way, and for example, as shown in FIG. 17, the first supporting part 5 may be arranged such that the first supporting apparatus 50 is disposed only at the front of the bus duct 30 in front view, or the like, properly, allowing reduction in the quantity of parts, and also eliminating the necessity of installation at places such as the rear face, for example, where it is hard to reach hands, which makes it possible to reduce the labor power for execution. Of course, the first supporting apparatuses 50 of the first supporting part 5 may be provided respectively on both sides in the lateral direction of the duct 30 to support the bus duct 30, and the second supporting apparatus 60 of the second supporting part 6 may be provided only on one side in the thickness direction of the duct 30 to support the duct 30. Likewise, in the other embodiments, the quantities and the state of disposition of the supporting apparatuses that construct respective supporting parts can be set properly, and for example, a supporting part may be constructed with a single supporting apparatus.

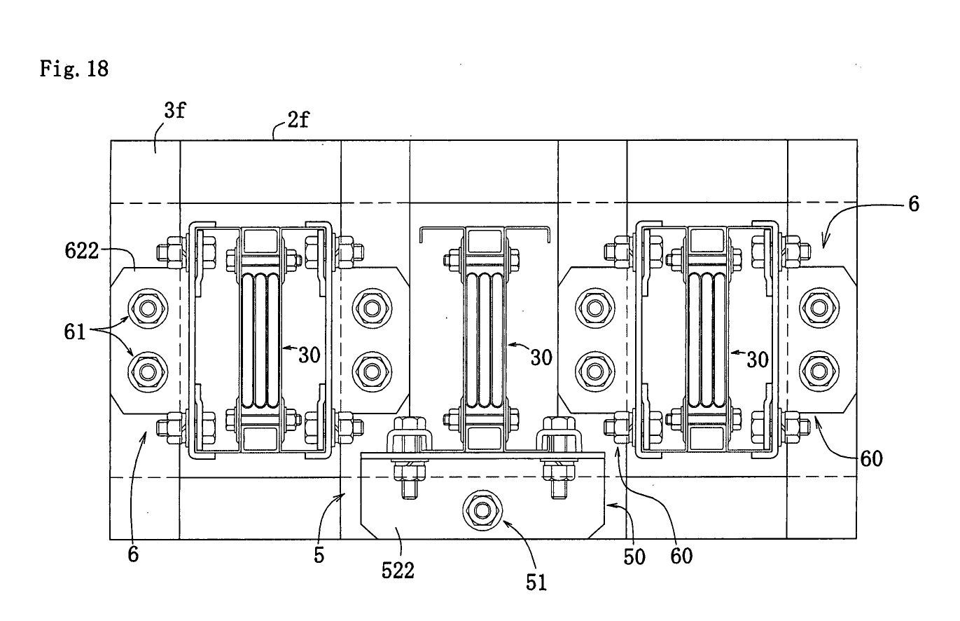

Further, for example, as shown in FIG. 18, a construction in which the first supporting part 5 is arranged such that the first supporting apparatus 50 is provided on one side in the lateral direction of the bus duct 30, and a spring member 51 that supports a supporting piece 522 of the first supporting apparatus 50 and the spring material thereof are provided in a quantity of one, a construction in which the first supporting part 5 is arranged such that the first supporting apparatuses 50,50 are provided respectively on both sides in the lateral direction of the bus duct 30, the spring member 51 that supports the supporting piece 522 of the respective first supporting apparatus 50 and the spring material thereof are provided in a quantity of one, and the duct 30 is supported by the spring members 51,51 in a total quantity of two of the front and rear first supporting apparatuses 50, 50 or by the spring materials thereof, and other constructions can be applied properly. For example, the case that it is required to support the bus duct 30 only with a light force, and the case that there is a difference in the capacity or weight of bus ducts, or a difference in the type of bus ducts, can be easily dealt with, making it possible to deal with any execution site. Further, a construction in which the spring member 61 that supports the supporting piece 622 of the second supporting apparatus 60 of the second supporting part 6 or the spring material thereof is provided in a quantity of only one for each, a construction in which the spring member 51 of the first supporting apparatus 50 of the first supporting part 5 or the spring material thereof, and the spring member 61 of the second supporting apparatus 60 of the second supporting part 6 or the spring material thereof, are arranged in the relationship therebetween as ‘three to one in quantity’, ‘one to three in quantity’, and the like, are possible in a proper way. Also, for another example, spring materials with different spring constants may be used for the first supporting apparatus 50 of the first supporting part 5 and the second supporting apparatus 60 of the second supporting part 6, and other proper constructions are possible.

Bus duct supporting apparatuses according to the invention include an apparatus which comprises, for example, the supporting part or the supporting apparatus, and the vibration insulating part of the first to third embodiments, with integration, and an apparatus which comprises the supporting part and the vibration insulating part with integration, regardless of any disposition such as the disposition of the supporting part that supports the duct 30 in the above embodiments, wherein one bus duct is supported by the supporting part, and another bus duct next to the one bus duct is insulated from vibration by the vibration insulating part.

1. A bus duct supporting structure for supporting bus ducts of a plurality of lines installed on a structure in parallel almost in the vertical direction, characterized in that each bus duct is supported by supporting parts that are fixedly installed on the structure, and the supporting parts that support one bus duct and the supporting parts that support another bus duct, the bus ducts being next to each other, are installed at a distance therebetween in the longitudinal direction of the bus ducts.

2. The bus duct supporting structure according to claim 1, characterized in that the bus ducts are installed in parallel penetrating through a plurality of floors of the structure, the one bus duct is supported by the supporting part while the other bus duct is not supported by the supporting part on a first floor, and the other bus duct is supported by the supporting part while the one bus duct is not supported by the supporting part on a second floor which is one floor higher than the first floor.

3. The bus duct supporting structure according to claim 1 or 2, characterized in that the bus ducts are installed in parallel penetrating through a plurality of floors of the structure, the one bus duct is supported by the supporting part that is fixedly installed on a ceiling on the first floor, and the other bus duct is supported by the supporting part that is fixedly installed on the floor on the second floor which is one floor higher than the first floor.

4. The bus duct supporting structure according to claim 1, 2, or 3, characterized in that vibration insulating parts that insulate vibration of predetermined bus ducts are provided.

5. The bus duct supporting structure according to claim 4, characterized in that the vibration insulating part is provided at the supporting part that supports the one bus duct or the other bus duct, and insulates vibration of the other bus duct or the one bus duct.

6. A bus duct supporting structure for supporting bus ducts of a plurality of lines that are installed in parallel in a same direction which is almost the vertical direction of a structure, characterized in that each bus duct is supported by a first supporting part that is fixedly installed on the structure and supported at an end part in the lateral direction of a bus duct, or by a second supporting part that is fixedly installed on the structure and supported at an end part of the thickness direction of a bus duct, wherein, almost at a same height or almost on a same floor, one bus duct is supported by the first supporting part, and another bus duct, the one bus duct and the other bus duct being next to each other, is supported by the second supporting part.

7. The bus duct supporting structure according to claim 6, characterized in that the bus ducts are installed penetrating through a plurality of floors of the structure, the one bus duct is supported by the first supporting part and the other bus duct is supported by the second supporting part on a first floor, and the other bus duct is supported by the first supporting part and the one bus duct is supported by the second supporting part on a second floor which is one floor higher than the first floor.

8. The bus duct supporting structure according to claim 6 or 7, characterized in that there is provided, at least, a place where a first supporting apparatus constructing the first supporting part is installed only at one end in the lateral direction of a bus duct, thereby supporting the bus duct, or a place where a second supporting apparatus constructing the second supporting part is installed only at one end in the thickness direction of a duct, thereby supporting a bus duct.

9. A bus duct supporting apparatus that is fixedly installed on a structure and supports a bus duct which is installed almost in the vertical direction of the structure, characterized in that, on a body of the supporting apparatus that supports the bus duct, a vibration insulating part that insulates vibration of another bus duct which is installed parallel to the former bus duct, the bus ducts being next to each other, is provided.
